(19) United States
(12) Patent Application Publication
(10) Pub. No.: US 2018/0199535 A1
(43) Pub. Date: Jul. 19, 2018

(54) TECHNIQUES FOR ENHANCED LITTER MANAGEMENT AND HANDLING

(71) Applicant: 9360-3561 QUÉBEC INC., Boucherville (CA)

(72) Inventors: Stéphane CHEVIGNY, Boucherville (CA); Shirley GOUGH, Boucherville (CA); Francis ROBERT, Boucherville (CA)

(73) Assignee: 9360-3561 Québec Inc., Boucherville, QC (CA)

(21) Appl. No.: 15/743,928

(22) PCT Filed: Jul. 14, 2016
(86) PCT No.: PCT/CA2016/050833

§ 371 Date: Jan. 11, 2018

Related U.S. Application Data
(60) Provisional application No. 62/192,157, filed on Jul. 14, 2015.

(51) Int. Cl. A01K 1/01; B65D 83/08

(52) U.S. Cl. CPC A01K 1/011; B65D 83/08

(57) ABSTRACT

A litter box kit is provided. The litter box kit comprises a top cover; a base mountable to the top cover to form a chamber for accommodating an animal, the base comprising: a bottom section; and side walls extending upward from the bottom section to define a base cavity, wherein at least one of the side walls comprises an opening; a cartridge sized and configured to be insertable through the opening and into the base cavity, the cartridge comprising: a housing comprising a bottom part, side walls, and a removable top part defining a cartridge chamber; and litter material provided within the cartridge chamber and being exposed below the chamber upon removal of the top part; and a garbage bag dispenser comprising: tubular plastic stock; and an annular body comprising a compartment for housing the tubular plastic stock, the body being removably mountable to the base and sized and positioned about an exit opening provided in the base such that the cartridge is removable through the exit opening and into a portion of the tubular plastic stock for disposal.

### TECHNICAL FIELD

The technical field general relates to litter boxes and more particularly litter boxes that may have removable cartridges containing litter material and an integrated garbage bag dispenser.

### BACKGROUND

There are several types of known litter boxes. First, traditional boxes typically include a base and a cover with an entrance that may have a hinged door that prevents litter from exiting the box. The entrance of some litter boxes can also be provided on the top of the litter box. Such traditional litter boxes can be made of plastic or other materials, and have a capacity of about 5-18 kg of liter depending on the type of liter used. These litter boxes require regular maintenance and cleaning, generally with a slotted shovel, thus requiring the user to manipulate the soiled litter on a regular basis.

Secondly, manual screen type litter boxes include a manual cleaning mechanism that includes a manual screen that facilitates removing excrement from the litter box. Generally, the user flips or rolls the litter box or removes the screen in order to remove the excrement and soiled portions of the litter from the rest of the litter which remains in the litter box. These litter boxes also require regular manipulation by the user, and have a capacity of about 5-18 kg of liter depending on the type of liter used. The manual screening mechanism can be a simple sifting panel or can include a grill system that deposits the waste into a pull-out tray.

Thirdly, motorized or “self-scooping” litter boxes include an automatic or motorized cleaning mechanism. Such litter boxes are designed to reduce the manual manipulation of the litter by including an automatic mechanism for removing waste from the litter. The automated mechanism can include a robotic comb or an automatic rotation system that remove waste from the litter and place it in a collection compartment. Generally, the user must set up and plug in the apparatus to an electrical power source to enable the automated functions. The litter remains in the litter box while the automated waste removal system is at work. These litter boxes require the user to manually supply the litter into the base compartment and to remove the collected waste material from the collection compartment for disposal on a regular basis. Such litter boxes generally have a capacity of about 5-18 kg of litter depending on the type of liter used.

Fourthly, waste collection litter boxes include non-absorbent litter material allowing urine to pass through the material toward the bottom of the litter box where it is collected in a compartment that may include an absorbent disposable pad. The user must replace the absorbent urine-soiled pad and must also remove the feces that accumulate on top of the non-absorbent litter material.

There are various drawbacks related to known litter boxes as well as the transport, replacement, management, and disposal of litter.

### SUMMARY

In some implementations, there is provided a litter box kit, comprising: a top cover; a base mountable to the top cover to form a chamber for accommodating an animal, the base comprising: a bottom section; and side walls extending upward from the bottom section to define a base cavity, wherein at least one of the side walls comprises an opening; a cartridge sized and configured to be insertable through the opening and into the base cavity, the cartridge comprising: a housing comprising a bottom part, side walls, and a removable top part defining a cartridge chamber; and litter material provided within the cartridge chamber and being exposed below the chamber upon removal of the top part; and a garbage bag dispenser comprising: tubular plastic stock; and an annular body comprising a compartment for housing the tubular plastic stock, the body being removably mountable to the base and sized and positioned about an exit opening provided in the base such that the cartridge is removable through the exit opening and into a portion of the tubular plastic stock for disposal.

In some implementations, there is provided a litter box, comprising: a top cover; and a base mountable to the top cover to form a chamber for accommodating an animal, the base comprising: a bottom section; and side walls extending upward from the bottom section to define a base cavity, wherein at least one of the side walls comprises an opening sized and configured for removably receiving a litter-containing cartridge by translational displacement through the opening and into the base cavity.

In some implementations, the base further comprises a guide system for guiding the translational displacement of the litter-containing cartridge into the base cavity.

In some implementations, the guide system comprises a tongue-and-groove system.

In some implementations, the tongue-and-groove system comprises a groove provided on at least one of the side walls of the base, the groove being co-operable with a corresponding tongue of the litter-containing cartridge.

In some implementations, the tongue-and-groove system comprises a tongue provided on at least one of the side walls of the base, the tongue being co-operable with a corresponding groove of the litter-containing cartridge.

In some implementations, the tongue-and-groove system comprises a groove on a first side wall of the base and a tongue on an opposed second side of the base, the groove and tongue of the base being co-operable with a corresponding groove and tongue of the litter-containing cartridge.

In some implementations, the base further comprises a displacement-facilitating system for facilitating the translational displacement of the litter-containing cartridge into the base cavity.

In some implementations, the displacement-facilitating system comprises a roller system.

In some implementations, the roller system comprises a plurality of roller units mounted to the bottom section of the base.

In some implementations, each roller unit comprises a wheel for contacting the litter-containing cartridge, an axel about which the wheel is mounted, and a frame having an upper portion to which the axel is mounted and a lower portion mounted to the bottom section of the base.

In some implementations, the litter box further comprises a connection mechanism provided proximate to an exit opening provided on one of the side walls of the base, the connection mechanism being configured to connect a garbage bag dispenser to the corresponding side wall of the base.

In some implementations, the connection mechanism is provided about the exit opening and is configured to connect an annular body of the garbage bag dispenser about the exit opening such that a central aperture defined by the annular body is aligned with the exit opening.

In some implementations, the exit opening is the opening through which the cartridge is inserted.

In some implementations, the exit opening is provided on an opposed side wall to the opening through which the cartridge is inserted.

In some implementations, the bottom section and the side walls of the base have a one-piece molded plastic structure.

In some implementations, there is provided a disposable litter cartridge, comprising: a housing comprising a bottom part, side walls, and a top part defining a cartridge chamber, the top part comprising a removable top portion and the bottom part and the side walls of the housing comprising a structural layer and an impermeable layer, the housing being sized and configured for removable insertion through an opening in a litter box; and litter material provided within the cartridge chamber and being upwardly exposable upon removal of the top part, the impermeable layer being adjacent to the litter material.

In some implementations, the housing is sized to receive at most 3 kg of the litter material in the cartridge chamber.

In some implementations, the housing is sized to receive between 500 g and 2.5 kg, or between 800 g and 2.5 kg or between 1.5 kg and 2.5 kg of the litter material in the cartridge chamber.

In some implementations, the housing is sized such that in the cartridge chamber has volume between 1000 cm³ and 2500 cm³.

In some implementations, the housing is sized such that in the cartridge chamber has volume between 1750 cm³ and 2250 cm³.

In some implementations, the structural layer comprises cardboard.

In some implementations, the structural layer comprises polymeric material.

In some implementations, the impermeable layer comprises a coating directly applied to the structural layer.

In some implementations, the impermeable layer comprises a wax coating.

In some implementations, the impermeable layer comprises a liner.

In some implementations, the removable top portion is a tear-away portion.

In some implementations, the cartridge further comprises a handle fixed to a front side wall of the housing.

In some implementations, the cartridge further comprises at least one odor-controlling substance.

In some implementations, the at least one odor-controlling substance is provided mixed with the litter material.

In some implementations, the at least one odor-controlling substance is provided as a coating, treatment, component of the housing.

In some implementations, the at least one odor-controlling substance comprises a chemical compound enabling bacteria and enzyme management or inhibition.

In some implementations, there is provided a garbage bag dispenser for use with a litter box, comprising: tubular plastic stock; an annular body defining a central aperture and comprising a compartment for housing the tubular plastic stock, the annular body being removably mountable about an exit opening provided in a side wall of the litter box such that the central aperture is aligned with the exit opening for receiving a soiled litter-containing cartridge there-through and into a portion of the tubular plastic stock extending outward from the annular body away from the side wall of the litter box.

In some implementations, the annular body is generally rectangular, and may optionally have rounded corners.

In some implementations, the dispenser further comprises at least one odor-controlling substance.

In some implementations, the at least one odor-controlling substance is provided as a coating, treatment, component of the tubular plastic stock.

In some implementations, the at least one odor-controlling substance comprises a chemical compound enabling bacteria and enzyme management or inhibition.

In some implementations, the annular body comprises connection apertures for receiving connectors to mount the annular body to the base.

In some implementations, a litter box is provided. The litter box comprises: a top cover; and a base mountable to the top cover to form a chamber for accommodating an animal, the base comprising: a bottom section; and side walls extending upward from the bottom section to define a base cavity, wherein at least one of the side walls comprises an opening sized and configured for removably receiving a litter-containing cartridge by translational displacement through the opening and into the base cavity, wherein the base is adapted to receive a garbage bag dispenser comprising: tubular plastic stock; and an annular body comprising a compartment for housing the tubular plastic stock, the annular body being removably mountable to the base and positionable about the opening of the base such that the litter-containing cartridge is removable through the opening and into a portion of the tubular plastic stock for disposal.

In some implementations, a method for removing a litter-containing cartridge from a base of a litter box is provided. The method comprises: dispensing a portion of tubular plastic having a first end and a second end from a garbage bag dispenser mounted to the base of the litter box and positioned about an opening of the base; sealing the portion of tubular plastic at the first end and keeping the second end connected to a tubular plastic stock housed in the garbage bag dispenser; translationally displacing the litter-containing cartridge out of the base of the litter box, through the opening and into the sealed portion of tubular plastic; severing the portion of tubular plastic from the tubular plastic stock at the second end; and sealing the portion of tubular plastic at the second end and around the litter-containing cartridge.

In some implementations, sealing the portion of tubular plastic at the first and second ends comprises tying off the portion of tubular plastic.

In some implementations, translationally displacing the litter-containing cartridge comprises pulling the litter-containing cartridge out of the base of the litter box.

In some implementations, pulling the litter-containing cartridge is performed by pulling on a handle provided on the litter-containing cartridge, through the sealed first end of the portion of tubular plastic.

In some implementations, translationally displacing the litter-containing cartridge comprises pushing the litter-containing cartridge out of the base of the litter box by insertion of a second litter-containing cartridge into the base, via a second opening provided in the base.

In some implementations, severing the portion of tubular plastic comprises cutting the portion of tubular plastic.

In some implementations, the litter box is a cat litter box.

In some implementations, the kit, the litter box, the cartridge, the garbage bag dispenser or the method, or any combination thereof, as described above, can further include at least one feature as defined in one or more of the above paragraphs and/or in the description and/or in the drawings. For example, an indicator system can be included and/or other features can be included when combining the various components.

### BRIEF DESCRIPTION OF THE DRAWINGS

FIG. 1 is a side view of a litter box, according to an embodiment.

FIG. 2 is a top perspective view of a base component of a litter box and a cartridge, according to an embodiment.

FIG. 3 is a top perspective view of a base component of a litter box and a cartridge, according to another embodiment.

FIG. 4a is a top perspective view of a litter cartridge, according to an embodiment.

FIG. 4b is a front plan view of the litter cartridge of FIG. 4a.

FIG. 4c is a side plan view of the litter cartridge of FIG. 4a.

FIG. 4d is a top plan view of the litter cartridge of FIG. 4a.

FIG. 5 is a top perspective view of a base component of a litter box, according to an embodiment, for receiving the litter cartridge of FIGS. 4a-4d.

FIG. 6 is a perspective view of a wheel assembly.

FIG. 7 is a perspective close-up view of part of the base component of FIG. 5.

FIG. 8a is a top perspective view of a base component of a litter box, according to an embodiment, for receiving the litter cartridge of FIGS. 4a-4d.

FIG. 8b is a front plan view of the base component of FIG. 8a.

FIG. 8c is a side plan view of the base component of FIG. 8a.

FIG. 8d is a top plan view of the base component of FIG. 8a.

FIG. 9 is a perspective close-up view of part of the base component of FIG. 5, into which the litter cartridge of FIGS. 4a-4d is inserted.

FIG. 10 is a perspective view of a garbage bag dispenser, according to an embodiment.

FIG. 11 is a perspective view of a garbage bag dispenser illustrating fastener openings, according to another embodiment.

FIG. 12 is a close-up perspective view of part of the garbage bag dispenser of FIG. 11.

FIG. 13 is a perspective view of part of a fastener for the garbage bag dispenser of FIG. 11.

FIG. 14a is a top perspective view of a base component of a litter box, according to another embodiment.

FIG. 14b is a side plan view of the base component of FIG. 14a.

FIG. 14c is a top plan view of the base component of FIG. 14a.

FIG. 14d is a top exploded view of the base component of FIG. 14a.

FIG. 14e is a bottom exploded view of the base component of FIG. 14a.

FIG. 14f is a partially exploded view of the base component of FIG. 14a, wherein the garbage bag dispenser is inserted around an opening.

FIG. 15a is a top exploded view of a base component of a litter box, wherein apertures are provided in the lateral walls and the bottom surface, according to yet another embodiment.

FIG. 15b is a bottom exploded view of the base component of FIG. 15a.

FIG. 16a is a close-up schematic view of a handle of a litter cartridge, according to an embodiment.

FIG. 16b is a close-up schematic view of a handle of a litter cartridge, according to another embodiment.

FIG. 17a is a cross-sectional schematic view of a litter cartridge including an absorbent pad, according to an embodiment.

FIG. 17b is a cross-sectional schematic view of a litter cartridge including a slotted absorbent pad, according to another embodiment.

FIG. 18a is a cross-sectional schematic view of a litter cartridge including a cover.

FIG. 18b is a top perspective schematic view of the litter cartridge of FIG. 18a.

FIG. 18c is a close-up view of a recess of an inner wall of a litter cartridge, according to an embodiment.

FIG. 19 is a schematic top plan view of the steps to remove a disposable cartridge from the base component, according to an embodiment.

FIG. 20 is a schematic top plan view of the steps to remove a disposable cartridge from the base component, according to another embodiment.

### DETAILED DESCRIPTION

Various techniques are described related to litter box components that provide advantageous litter management and handling. In some scenarios, a disposable cartridge that contains litter material is provided and can be removably integrated into a litter box so that excretions can accumulate in the cartridge litter. The cartridge can be inserted into a base component of the litter box for use, and once soiled the cartridge can be removed from the base component for replacement by a fresh cartridge, thereby reducing user handling of the litter and waste material. A garbage bag dispenser (which can be referred to as a dispenser “cartridge” or dispenser “cassette”) can also be integrated with the base component of the litter box, such that a soiled cartridge can be removed directly into a garbage bag for disposal, which can further reduce user handling of the litter and waste material.

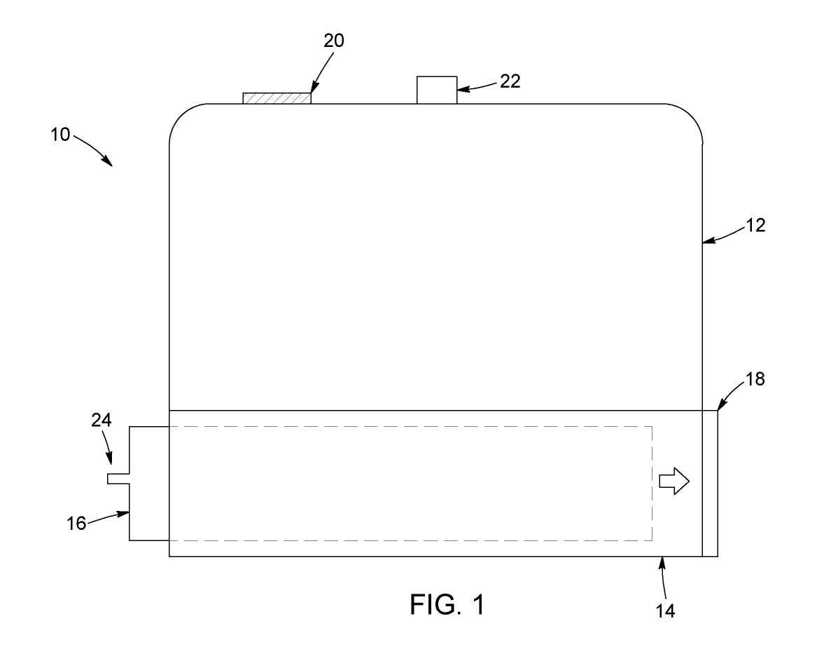

Referring to FIG. 1, a litter box 10 includes a top cover 12 and a base 14 that can be coupled together to define a chamber for the animal. The base 14 and the top cover 12 can be coupled in various ways, optionally removably coupled together which clips or the like. The top cover 12 can have an enclosed upper part, as illustrated, or can be in the form of an open ended lip cover. When a lip cover is used, the resulting chamber is open-ended at the top. The base 14 has a bottom section and side walls defining a cavity that is sized and configured to receive a litter-containing cartridge 16, which will be further discussed below. The cartridge 16 can be inserted horizontally into the cavity of the base 14 without removing the top cover 12. Once positioned within the cavity, the cartridge 16 has an open top exposing the litter and enabling the animal to excrete onto the litter. Once the litter has been soiled, the cartage 16 can be removed from the base 14 in various ways, e.g., by pulling the cartridge 16 via the same opening into which it was inserted or by displacing the cartridge 16 out of the other end of the base 14, depending on the construction of the base 14. In some scenarios, a garbage bag dispenser 18 is integrated onto the base 14 such that the soiled cartridge 16 can be removed from the base 14 directly into a garbage bag.

Still referring to FIG. 1, the top cover can have a number of features, such as a carbon filter 20, a transport handle 22, and so on. The entrance can include an opening in the top cover, and may or may not include a pivoting door. The cartridge 16 can have a number of features, such as a handle 24, and so on.

### Base Implementations

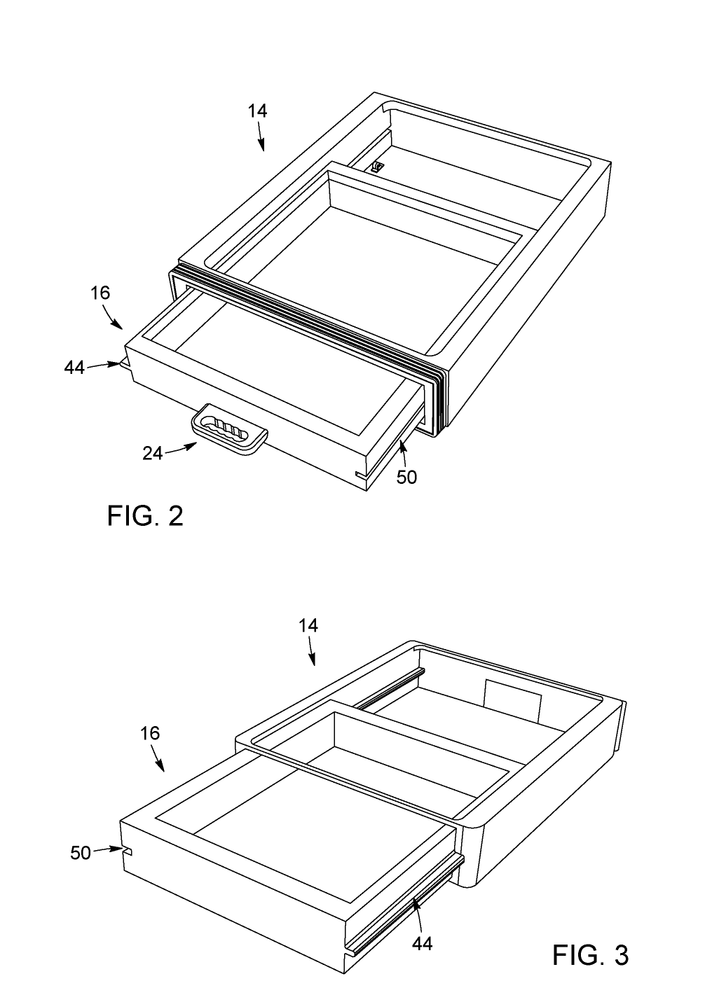

FIGS. 2 and 3 show the base 14 of the litter box 10, the cartridge 16 partially inserted within the cavity of the base via an opening, and the garbage bag dispenser provided around the opening. In this implementation, the garbage bag dispenser is mounted around the same opening through which the cartridge 16 is inserted, but it should be noted that the garbage bag dispenser can alternatively be mounted on other parts of the base such that the soiled cartridge can be removed directly through an annular construction of the garbage bag dispenser into one of the garbage bags. “Annular” should be understood to mean a structure having a perimeter and defining a central opening, and which may have various forms such as generally oval, rectangular, rectangular with rounded corners, etc. It should also be noted that the “annular” construction preferably includes structure where the central opening is enclosed by the surrounding body, although the central opening may in some scenarios be open. FIG. 2 also shows various features of the base 14, including its shape and the corresponding shape of the cartridge 16.

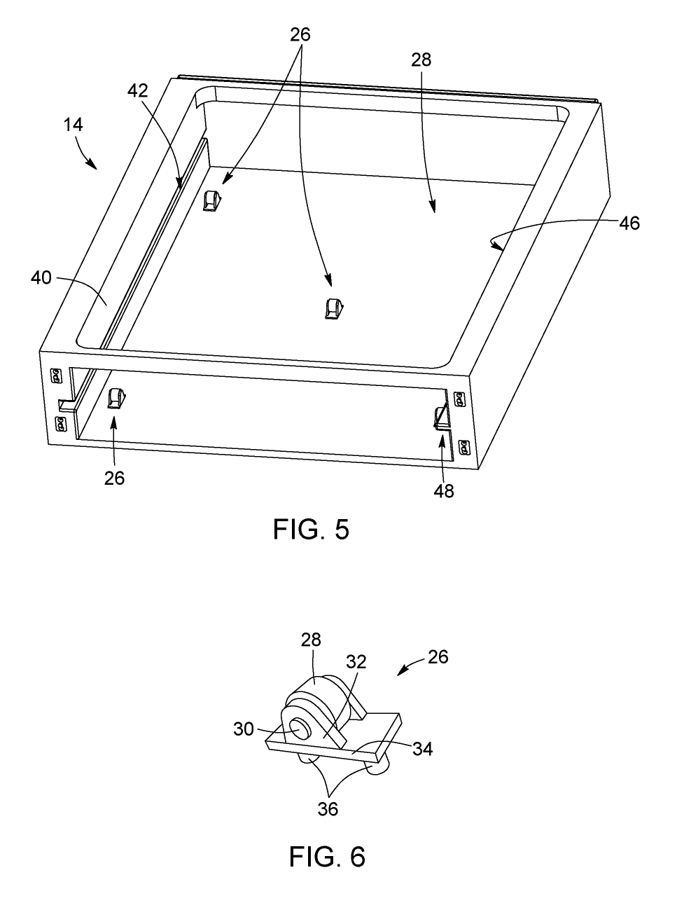

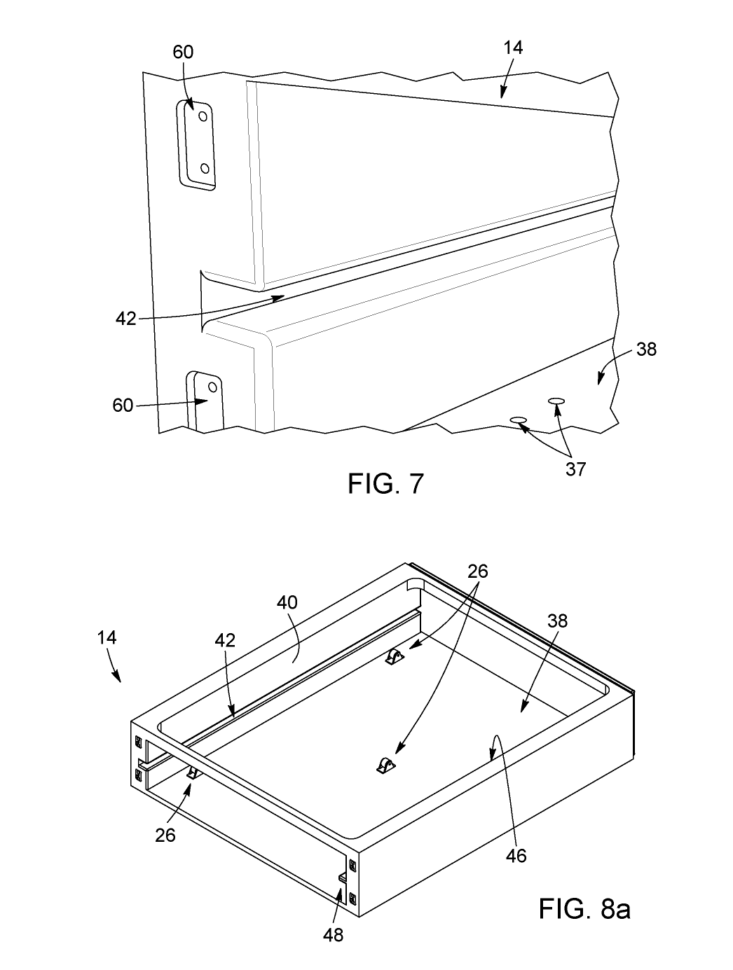

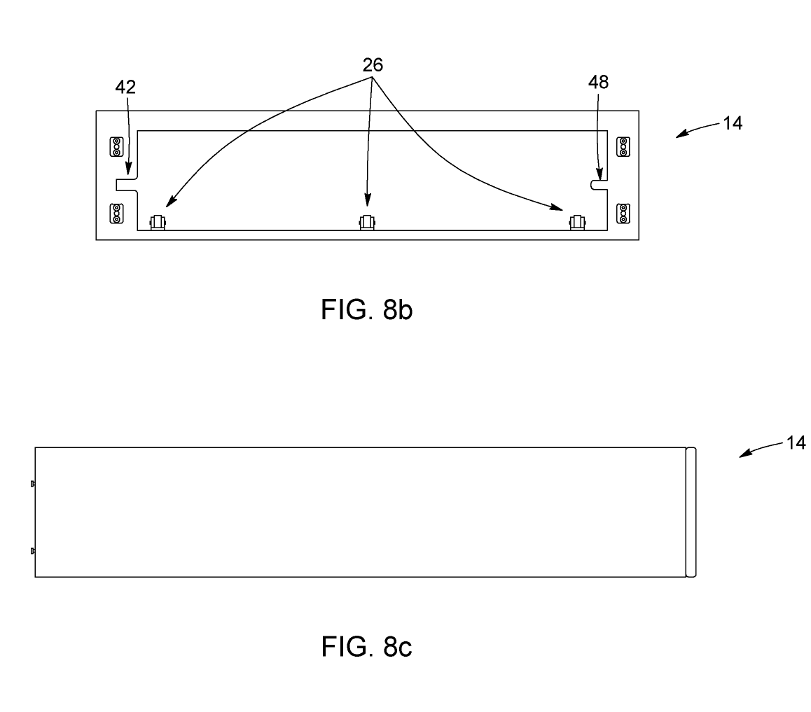

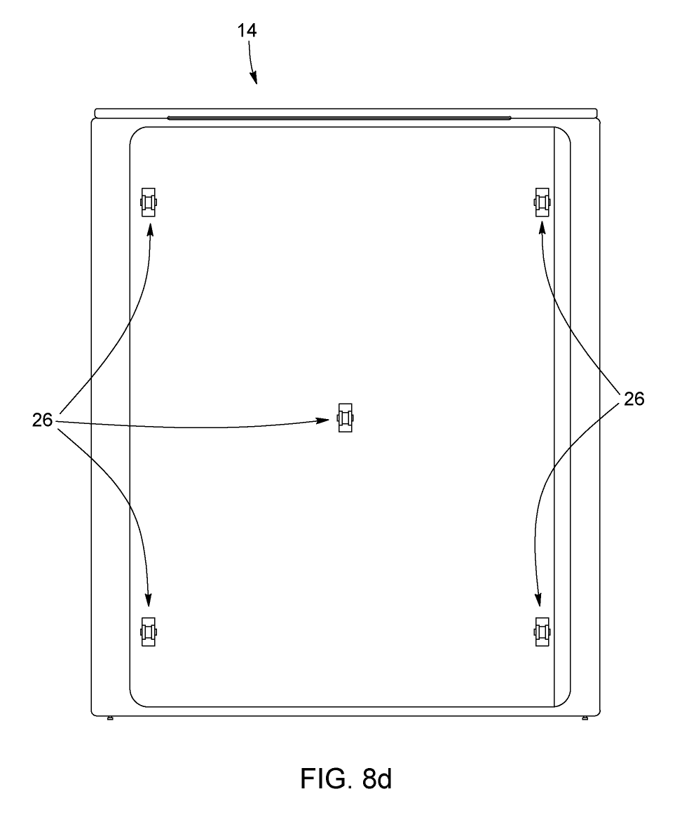

Referring now to FIGS. 5 and 8a, the base 14 can include a roller system for facilitating insertion of the cartridge 16. For example, the roller system can include roller units 26, such as those illustrated in FIG. 6. The roller units 26 can include a wheel 28 mounted to an axel 30 that is coupled to a roller frame 32 that has a base component 34 with connectors 36, such as downward projecting pegs for insertion into corresponding apertures 37 in the bottom section of the base 14 as shown in FIG. 7. Alternatively, other connection systems can be used to connect the base 14 to the roller units 26. It should also be noted that other displacement-facilitating systems can be used instead of or in combination with a roller system, to facilitate insertion of the cartridge. It should also be noted that the base 14 may be configured so that the cartridge 16 can be positioned within the cavity in other ways and via other directions that may not require displacement-facilitating systems, e.g., by placing the cartridge into the cavity of the base 14 from above via the upper open end. Horizontal or lateral insertion may be preferred, however, to further reduce user handling and exposure with respect to the litter.

Referring to FIGS. 2, 3, 4a to 4d, 5, 7 and 8a, the base 14 can also include a guide system for guiding the cartridge 16 into the cavity of the base 14. In some implementations, the base 14 can include grooves and/or tongues which can cooperate with corresponding tongues and/or grooves provided on the cartridge 16. In some scenarios, a first side wall 40 of the base 14 includes a groove 42 that cooperates with a tongue 44 of the cartridge 16, and a second side wall 46 of the base 14 includes a tongue 48 that cooperates with a groove 50 of the cartridge 16. An example cartridge for such a configuration is illustrated in FIGS. 2, 3, 4a and 4b.

In terms of the openings provided in the base 14 to allow insertion and removal of cartridges, there are several potential options. For example, as illustrated in FIG. 2, the base 14 may include a single front opening through which the cartridge 16 is inserted and removed. Alternatively, the base 14 may include first and second openings so that the cartridge 16 can be inserted via the first opening (e.g., front) and removed via the second opening (e.g., back), in which case the garbage bag dispenser can be mounted proximate to or around the second opening. The first and second openings can be on opposite ends of the base 14 so that the cartridge 16 is displaced in a generally single and linear direction for insertion/removal.

In some implementations, the base 14 and cartridge 16 are sized and configured so that there is sufficient vertical space between the upper surface of the cartridge 16 and upper parts of the base 14 so that when the cartridge 16 is removed its upper surface does not contact any parts of the base 14. This clearance facilitates no soiled litter or waste material from contacting the litter box components.

The base 14 may also have various elements configured and positioned to hold or secure the cartridge 16 within the cavity during use. The guide system may aid in retaining the cartridge 16 in the desired position, and there may be other elements that aid in retaining the cartridge 16 laterally and/or longitudinally.

In some implementations, the base 14 may include an indicator system for indicating whether or not the cartridge 16 is positioned in a desired location. The indicator system can include a colored element (not shown) that can show through a transparent element (not shown) so that when the colored element and the transparent element are aligned it indicates that the cartridge 16 is in the right position. The transparent element can be a window on a side wall of the base 14, while the colored element can be provided on the side of the cartridge 16. For example, the cartridge 16 can have red and green color elements on its side, positioned such that the red element is visible through the window as the cartridge 16 is being inserted and then the green element becomes visible through the window once the cartridge 16 is aligned in the right location in the base 14. It is also possible to provide various other indicator systems that may be mechanical and/or electrically activated, such that when the cartridge 16 is inserted into the right position in the base 14, the indicator system has discernible (e.g., visible) indicator element that informs the user that the cartridge 16 is well positioned and thus is ready for use.

The base 14 may also have various dimensions that may correspond to the illustrated values (in centimeters) and each of the length, width, and height of the base elements defining the cavity can vary from the illustrated values within +/−1, 3, 5, 10 or 15 cm, for example. Other elements having dimensions illustrated in the drawings can each vary within +/−5%, 10%, 25% or 50%, for example. Corresponding dimensioning of the top cover, the cartridge 16 and the cassette can also be done.

The base 14 can be composed of various materials and can be constructed in various ways. For example, the base 14 can be made of a plastic material. In some implementations, anti-odor particles or scented particles can be incorporated into the base 14, or coated onto the base 14. In some embodiments anti-bacterial compounds or anti-bacterial particles can be incorporated into the base 14, or coated onto the base 14. For example, silver salts can be incorporated.

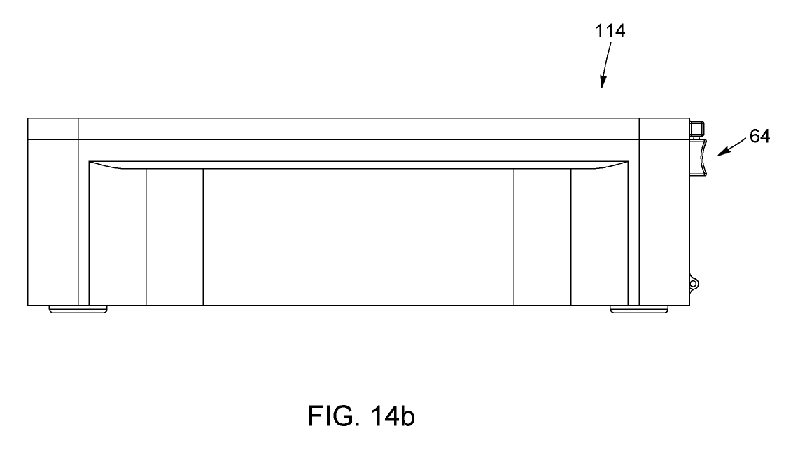

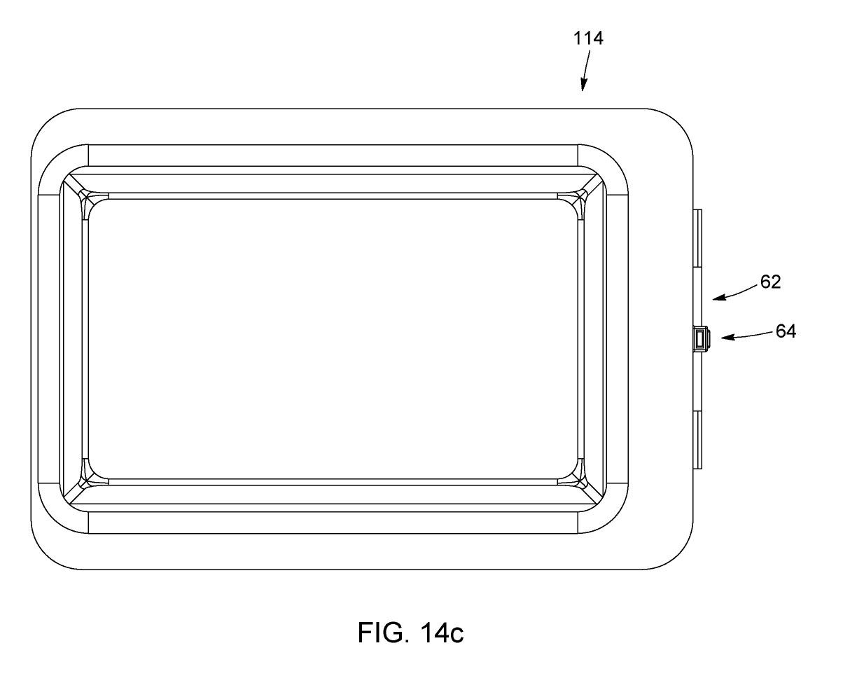

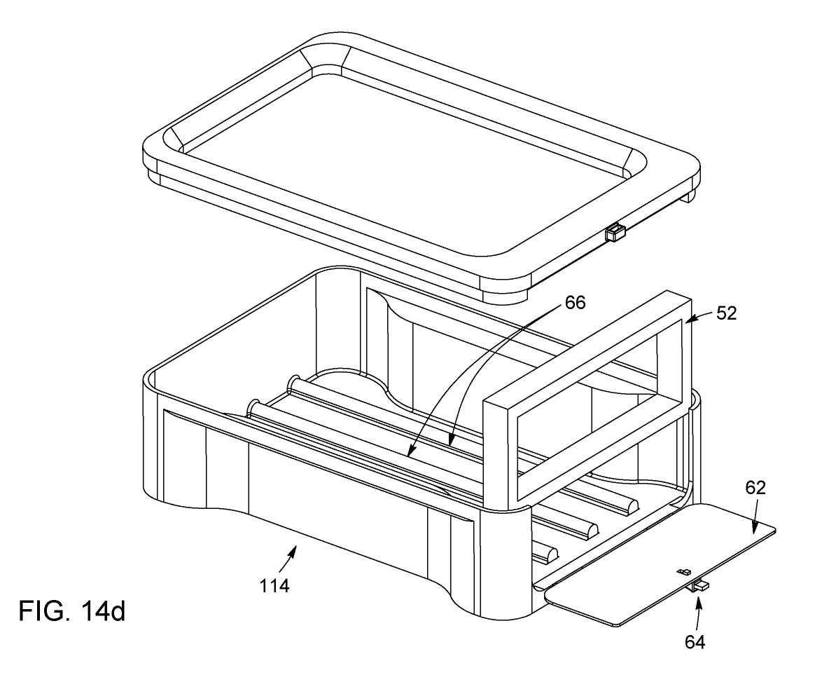

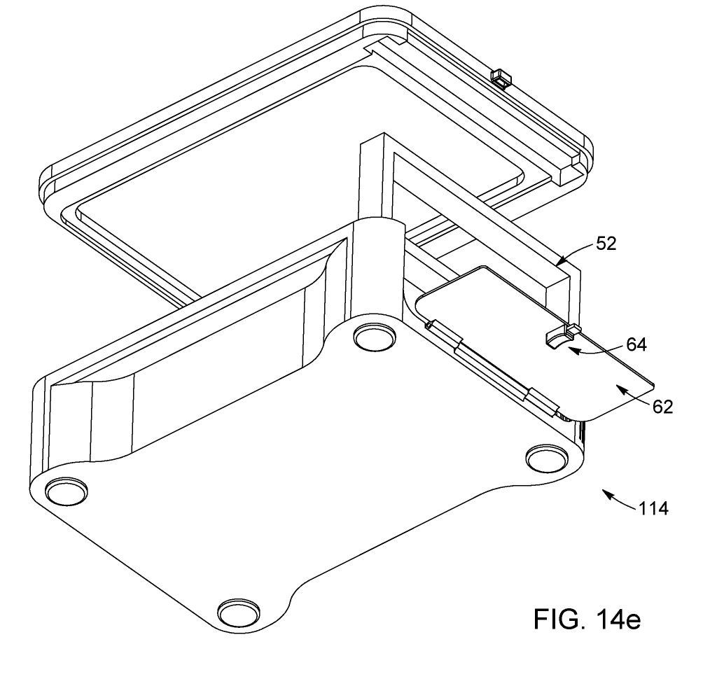

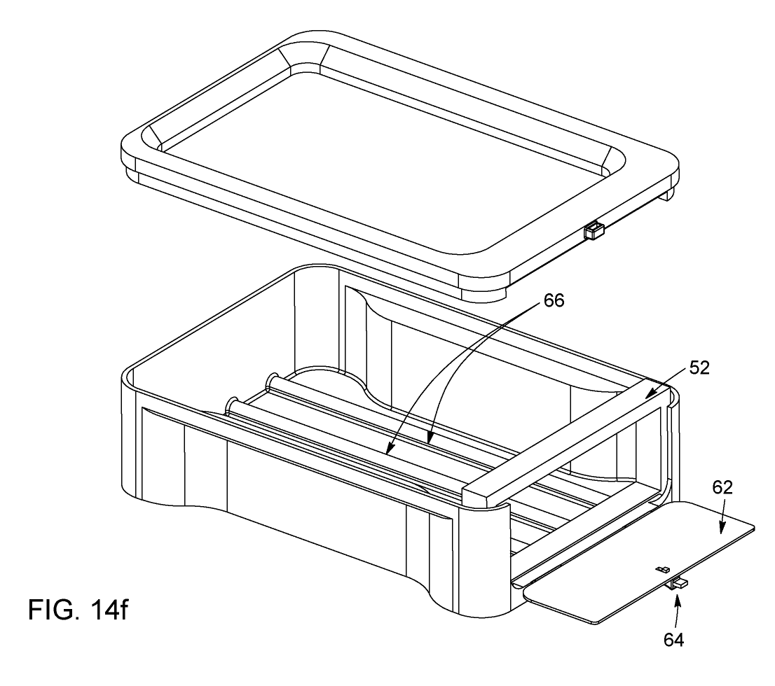

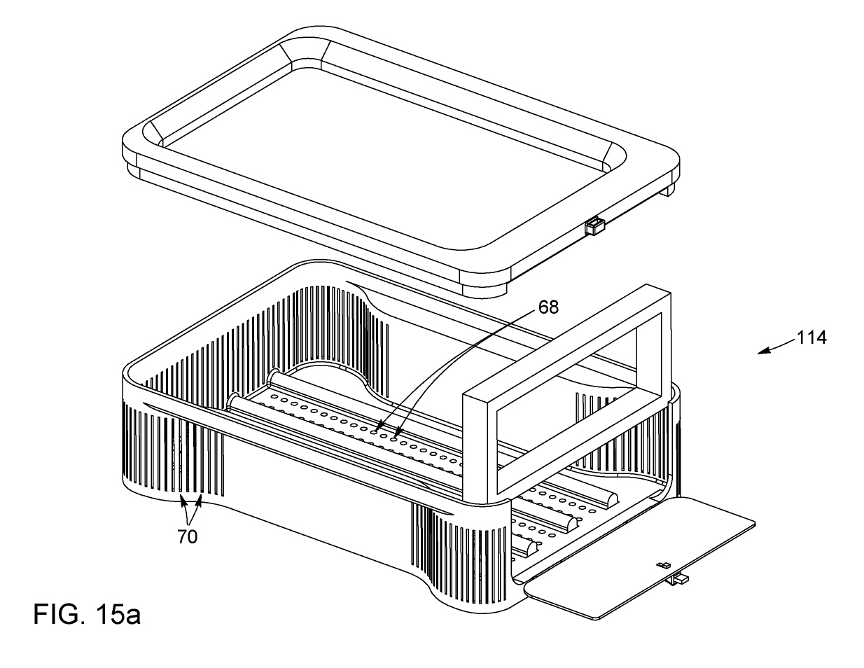

Now referring to FIGS. 14a to 14f, another example of a base 114 is shown. The base 114 includes a hinged door 62 defined as one of the faces of the base 114. The hinged door 62 can be securely closed via a locking mechanism 64. The hinged door 62 can opened to create an opening, so that a cartridge is insertable through the opening and into the cavity of the base 114.

In the embodiment shown at FIG. 14d, a garbage bag dispenser 52 can be removably inserted vertically into the base 114, such that the garbage bag dispenser is mounted around the same opening through which the cartridge is insertable. It should be noted that the garbage bag dispenser 52 can alternatively be mounted on other parts of the base such that the soiled cartridge can be removed directly through an annular construction of the garbage bag dispenser into one of the garbage bags.

Referring to FIGS. 14d and 14f, the base 114 can include a guide system for guiding the cartridge into the cavity of the base 114. In some implementations, the guide system can include grooves 66, which face upwards, and are provided on the bottom surface of the base 114. The grooves 66 can cooperate with corresponding cavities provided on a bottom surface of the cartridge (not shown), so that the cartridge can be slidably guided into the cavity of the base 114. In some embodiments, the base 114 can include a cover which can help retain the cartridge inside the base, and/or which can help retain the garbage bag dispenser in place.

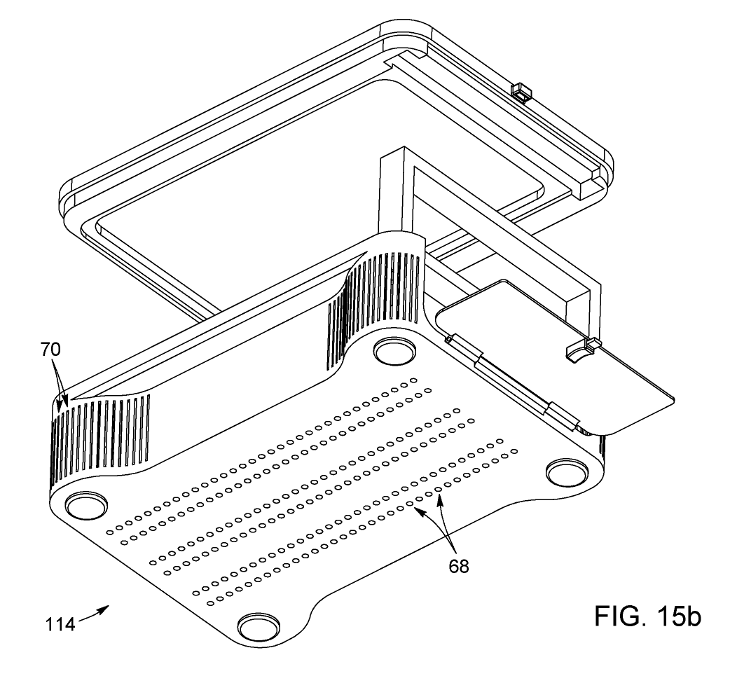

Now referring to FIGS. 15a and 15b, the base 114 can include perforations 68 provided in the bottom surface of the base 114, and perforations 70 provided in the side walls of the base 114 for circulating air. In some scenarios, the perforations 68, 70 can allow for an improved air circulation which can accelerate the drying of the soiled litter material, and in turn limit the formation of undesirable odor. In the example shown in FIGS. 15a and 15b, the perforations 68 have a circular shape and are provided between the grooves 66. The perforations 70 have a rectangular shape and are provided at the corners and back face of the base 114. It should be understood that the shape and positioning of the perforations 68, 70 shown in FIGS. 15a, 15b is exemplary only, and can vary. In some implementations, the interior of the sidewalls of the base 114 can have a convex shape such that the cartridge is retained therein more easily, as shown in FIG. 15a (i.e., the thickness of the sidewalls of the base 114 can increase from one end of the base 114 to the middle of the base 114 and then decrease from the middle of the base 114 to the second end of the base 114.

### Cartridge Implementations

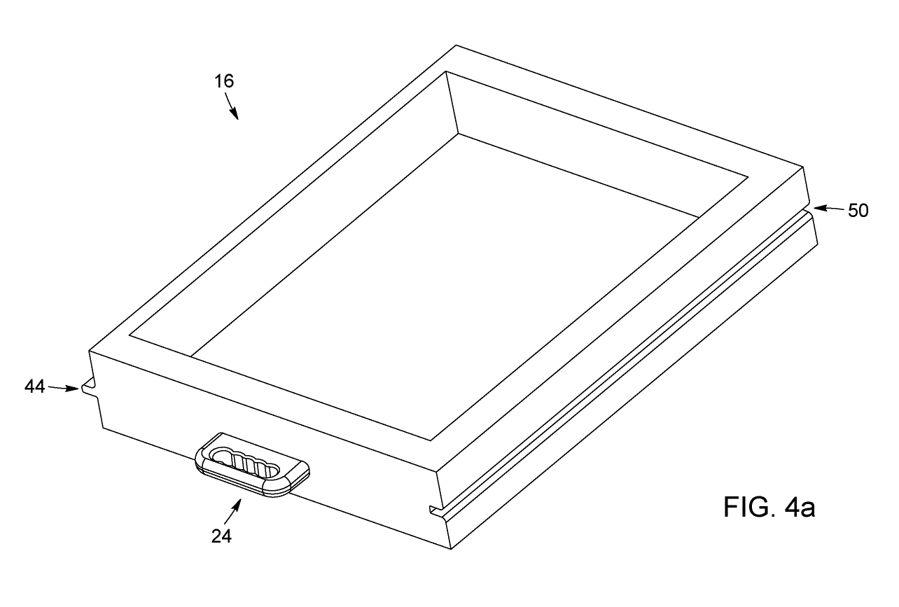

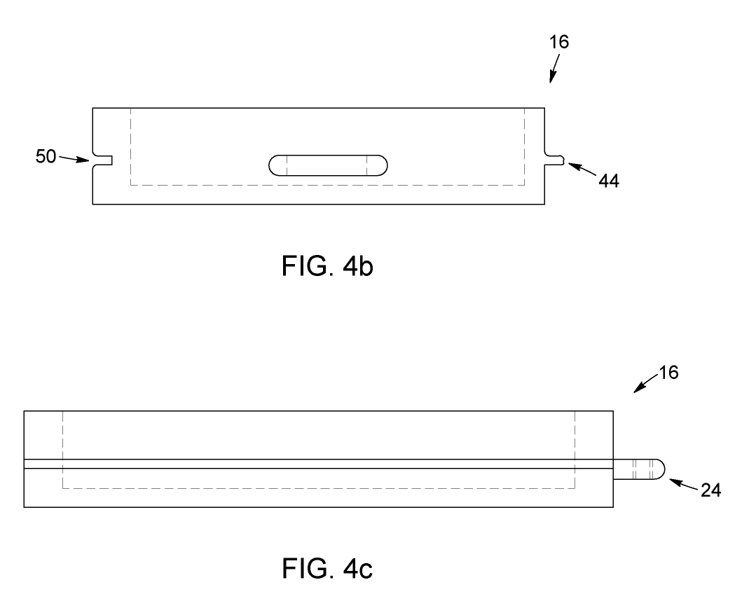

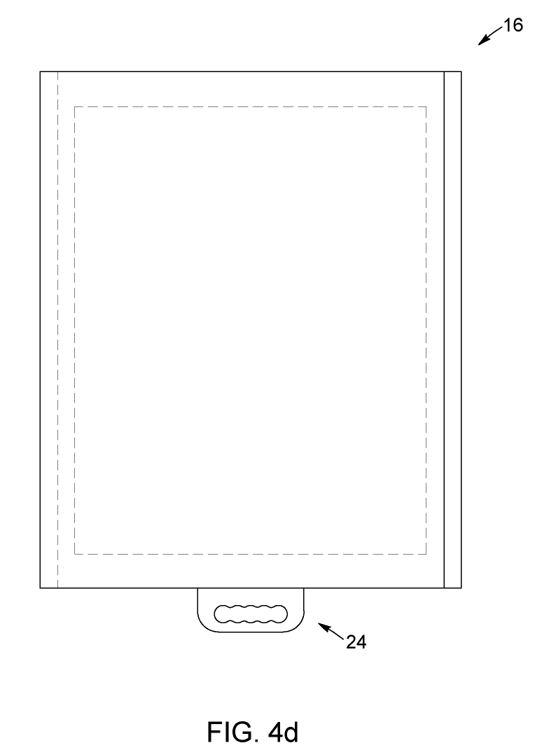

Now referring to FIGS. 4a to 4d, the cartridge 16 can have a main compartment having a generally box-shaped construction with a bottom section, side walls, and a top section defining a litter-containing chamber. The top section can include a tear-away or removable portion that can be removed prior to positioning within the base 14, to expose an upper surface of the litter material. The cartridge 16 can also have a handle 24 for facilitating carrying, insertion and/or removal during use. The cartridge 16 can also have a guide system (e.g., groove and/or tongue arrangement) for cooperating with the guide system of the base 14. The guide system can be provided on the lateral side walls of the cartridge 16 for cooperating with the guide system of the base 14, or can be provided on the bottom side wall (not shown) of the cartridge 16, for cooperating with the guide system of the base 114. There may be an impermeable layer or material adjacent to the litter containing chamber to avoid leakage of liquid waste material out of the cartridge 16 during use.

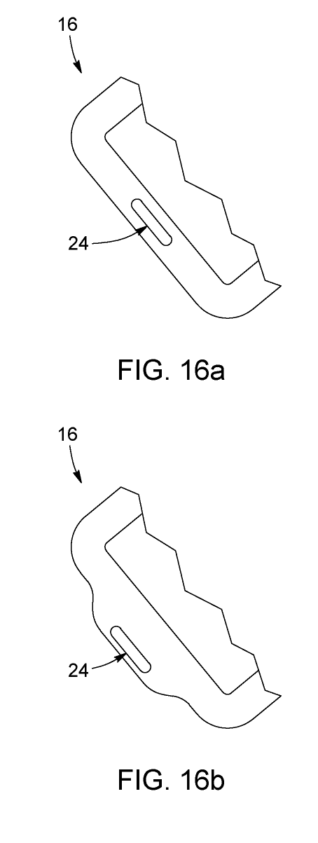

In some implementations, the handle 24 can be provided with a configuration and form to allow a user to both carry the cartridge 16 vertically (e.g., during transport) and insert/remove the cartridge 16 horizontally (e.g. during use with the base of the litter box). In some implementations, as shown in FIGS. 4a to 4d, the handle 24 can be provided on the front side wall of the cartridge 16. In other implementations, as shown in FIGS. 16a and 16b, the handle 24 can be embodied as a hole formed in an edge of the top surface of the cartridge 16. In some scenarios, the edge of the top surface of the cartridge 16 is larger around the handle 24, as seen in FIG. 16b. In some implementations, when the handle is embodied as a hole formed in an edge of the top surface of the cartridge 16, the width of the edge of the top surface of the cartridge 16, around the handle 24, is configured such that the edge can be abutted against a door of the base closing an opening of the base. The edge can also be configured such that the edge helps retain the cartridge inside the base and/or the garbage bag dispenser in place.

The cartridge 16 can be composed of various materials and can be constructed in various ways. In some implementations, the cartridge bottom and side walls include a structural layer and an impermeable layer. The structural layer can be composed of cardboard, polymeric materials, or a combination thereof, for example. The structural layer can be composed of a biodegradable material. The impermeable layer can be composed of a wax coating, a plastic liner, or another type of material. The impermeable layer can be laminated onto the structural layer. It should also be noted that additional layers or webs can be provided to enhance the structure, impermeability, or other characteristics of the cartridge 16.

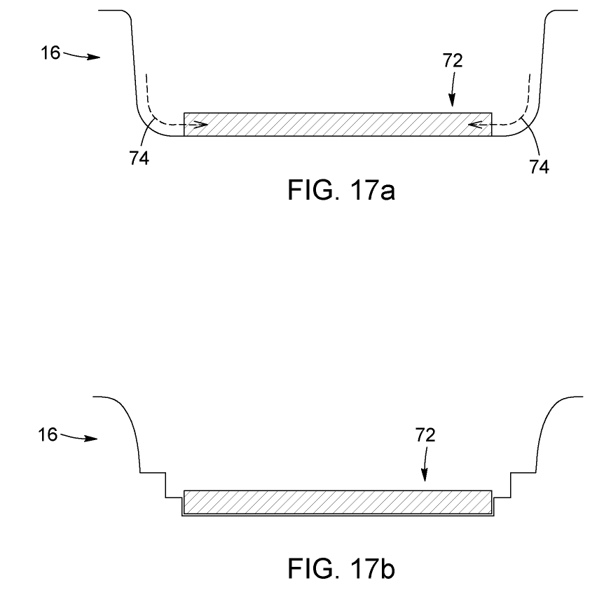

Now referring to FIGS. 17a and 17b, in some implementations, an absorbent pad 72 can be provided inside the cartridge 16, for example on top of the bottom surface of the cartridge 16. In some scenarios, the absorbent pad 72 is combined with non-clumping litter material, which can be provided inside the cartridge 16 and above the absorbent pad 72. The use of non-clumping litter material can allow for liquid from excrements to flow 72 downwards through the non-clumping litter material and towards the absorbent pad 72, in order to be absorbed thereby. In some implementations, the absorbent pad 72 can be a non-woven absorbent pad. In some scenarios, the top layer of the absorbent pad 72 can be reinforced for increased resistance against animal claws (e.g. cat claws). In some scenarios, the absorbent pad 72 can absorb liquid from its upper surface and/or from its side surfaces. In some implementations, the absorbent pad 72 can be an AirLaid™ absorbent pad. In some implementations, the bottom surface of the cartridge is configured such that the absorbent pad 72 can be slotted therein (as seen in FIG. 17b), such that the absorbent pad 72 is less prone to movement. In some implementations, the absorbent pad 72 can include superabsorbent polymers (SAP) and pulp, and/or may be constructed similar to puppy pad designs known in the art.

In some implementations, a chromogenic absorbent material can be provided inside or on the absorbent pad 72 and/or the litter material, in order to detect certain chemicals present in the animal excretion or in order to detect certain diseases (such as diabetes or feline lower urinary tract disease). Chromogenic absorbent materials which may be used are described in patent application No. PCT/CA2014/050140, which is incorporated herein by reference. In some implementations, the side-walls of the cartridge 16 can include perforations (not shown). In some scenarios, the perforations can allow for an improved air circulation which can accelerate the drying of the soiled litter material and/or the absorbent pad.

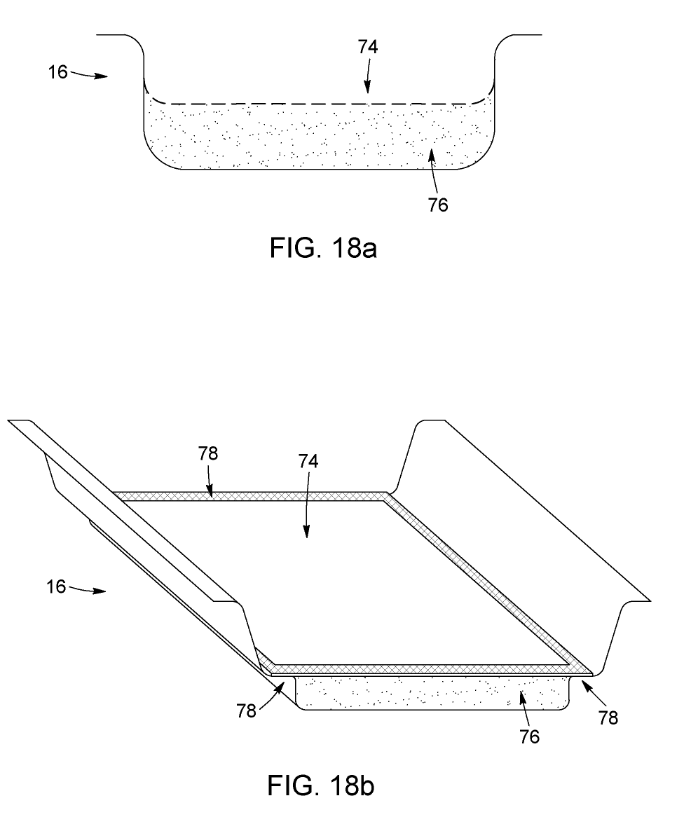

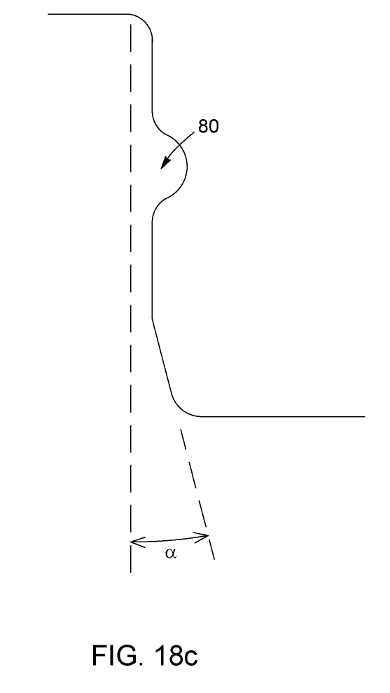

Now referring to FIGS. 18a and 18b, in some implementations, the cartridge 16 can include a removable cover 74 in order to prevent the litter material 76 to be spilled or lost during transportation of the cartridge 16. In some implementations, the removable cover 74 can be affixed on a portion of the sidewall of the cartridge, as seen in FIG. 18a. In other implementations, the sidewalls of the cartridge 16 can be configured in a stair-like configuration so that the removable cover 74 can be affixed on a platform 78, as seen in FIG. 18b. The removable cover 74 can be affixed to the cartridge 16 by various means. For example, the removable cover 74 can be glued such that it can be peeled off manually and without the need to use tools. In some scenarios, the removable cover can be glued via ultrasonic bonding. In some scenarios, the removable cover 74 is made of paper, plastic, a polymer blend or fabric.

In some implementations, the removable cover 74 of a cartridge is configured to withstand the weight of another cartridge which can be stacked thereon. In some scenarios, several cartridges can be stacked on top of one another.

It should be understood that the sidewall of the cartridge can have various configurations, and that the configurations shown in FIGS. 18a and 18b can vary. For example, as seen in FIG. 18c, the sidewall can be provided with a recess 80 which is configured to fit a corresponding groove provided on the sidewall of the base into which the cartridge is to be inserted. In some scenarios, parts of the lateral walls of the cartridge can be tilted by an angle α so as to be easily insertable and removable from the base while minimizing friction. For example, a can be chosen between 3° and 10°.

The cartridge 16 can be sized to accommodate up to 3 kg of litter material, optionally between 0.5 kg to 5 kg of litter material. Such weight ranges of the litter material can facilitate user handling, transport, and installation of the cartridges.

The cartridge 16 can also be sold with a covering, for instance for sale at retail outlets. The covering or packaging can include laminated cardboard, for example.

### Garbage Bag Dispenser Implementations

In some implementations, the garbage bag dispenser is removably mounted on part of the litter box to facilitate easy access to garbage bags into which the cartridge 16 can be placed for disposal. Various different types and constructions of garbage bag dispensers can be used, and each can be mounted to different parts of the litter box.

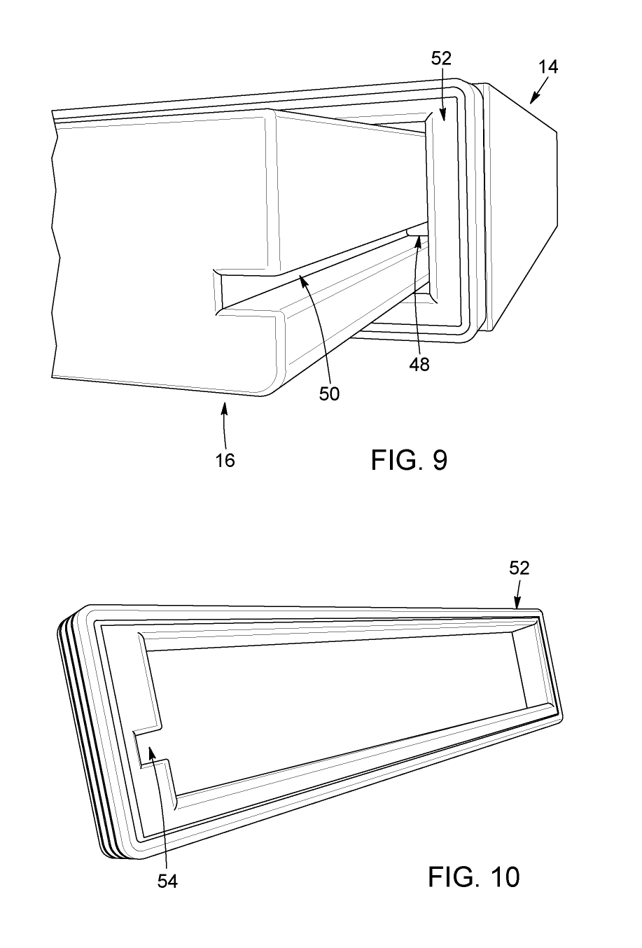

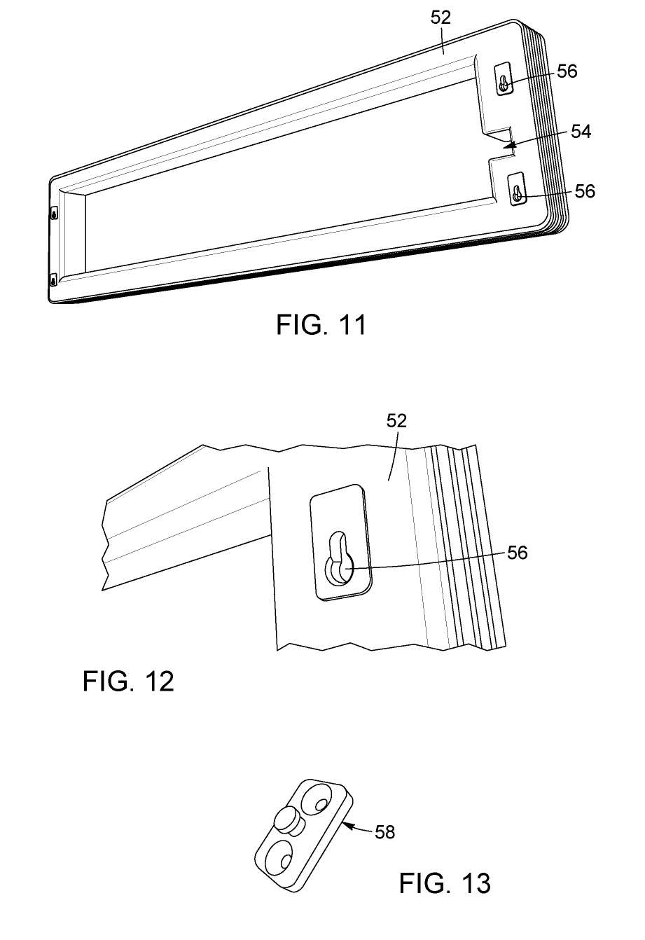

Referring to FIGS. 10 and 11, one example garbage bag dispenser 52 has an annular body that can be mounted around an opening in the base 14 of the litter box, as shown in FIGS. 2 and 9. The annular garbage bag dispenser 52 can be removably mounted about the perimeter of a side opening of the base 14, and provided with tubular plastic stock. A soiled cartridge 16 can thus be removed from the opening into an incremental portion of the tubular stock, which can be tied off at a distal end and then cut and tied off at a proximal end, thereby sealing in the soiled cartridge 16 for disposal. In some implementations, the garbage bag dispenser 52 includes tubular plastic stock and an annular body comprising a compartment for housing the tubular plastic stock (e.g., in pleated form), the body being removably mountable about an exit opening in the side wall of the base of the litter box. The central aperture defined by the tubular body is thus oriented to the side to enable the litter-containing cartridge to be removed by translational displacement there-through, and optionally a new cartridge can be inserted there-through by translational displacement into the base cavity. Various optional structural features of the annular garbage bag dispenser (which may also be referred to as a “cassette”) are described in U.S. Pat. No. 3,536,192, U.S. Pat. No. 6,974,029, U.S. Pat. No. 7,617,660 and/or U.S. Pat. No. 8,959,880, which are incorporated herein by reference, where the construction of the garbage bag dispenser and the part of the litter box (e.g., side opening of the base 14) are adapted to be co-operable and removably mountable with respect to each other. For instance, dispensers that are generally circular and are used for vertical insertion into a garbage receptacle can be adapted to have a shape for removable mounting about the opening in the side wall and to be oriented on the side rather than sitting at the top of the garbage receptacle.

FIGS. 10 and 11 illustrate a generally rectangular shape for the annular body of the garbage bag dispenser and the side opening of the base 14, but it should be noted that other shapes and dimensions can be used.

Referring to FIGS. 10 and 11, the body of the garbage bag dispenser 52 can include a notch 54 to allow the tongue 44 of the cartridge 16 to pass through.

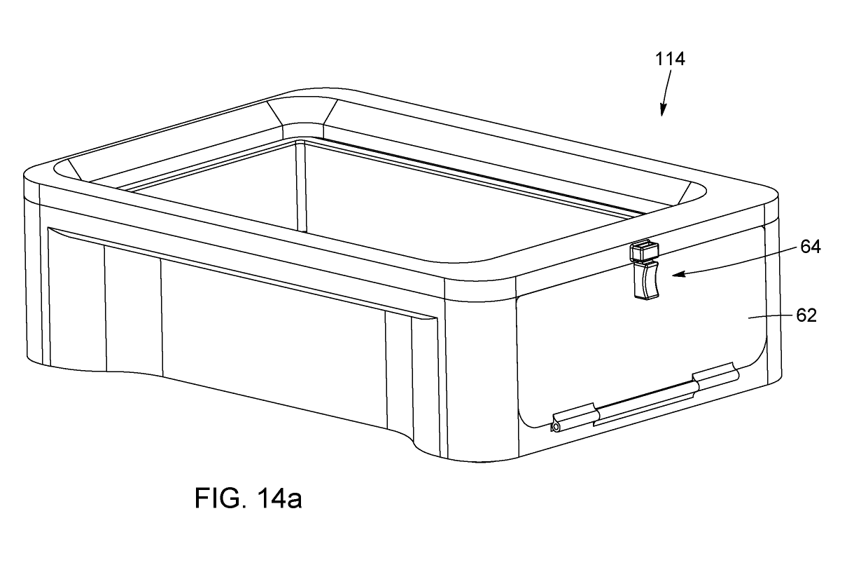

Referring to FIGS. 11 and 12, the garbage bag dispenser 52 can include a fastening system for fastening the garbage bag dispenser 52 to the litter box 10. For example, the fastening system can include apertures 56 provided through the body of the garbage bag dispenser 52 and corresponding pin units 58, as illustrated in FIG. 13, which can be mounted to the base 14 (for example via connection holes 60 as illustrated in FIG. 7) and then the pin units 58 can be inserted through the apertures 56 in the body of the garbage bag dispenser 52. The apertures 56 can be of various types and configurations. Alternatively, the garbage bag dispenser can be removably mounted to the base by various other mechanisms, such as a snap-fit construction.

In some implementations, the cartridge 16 is inserted by translational displacement through a first opening in the front side wall of the base and the garbage bag dispenser is mounted about a second opening in the back side wall of the base, such that the user can push out the soiled cartridge via the second opening by inserting a new fresh cartridge through the first opening. In this way, the pressure of the new cartridge on the soiled cartridge pushes the latter out of the second opening, through the central apertures of the annular body of the garbage bag dispenser, and then into the tubular plastic which can be tied off to seal in the soiled cartridge for disposal. The first and/or second openings can also be temporarily covered by respective hinged and/or removable panels.

In some implementations, the tubular plastic stock is hermetically sealable and is composed of a plastic material that is retains odors. Various different types of plastics and manufacturing processes can be used in connection with the tubular plastic stock, which may have various properties (e.g., hermetic, biodegradable, non-tearing, and so on).

### Litter Material Implementations

Various litter materials may be provided in the cartridge 16. For example, agglomerating or non-agglomerating litter (i.e., non-clumping litter) can be used. The litter may be clay-based, cereal-based, organic-based and/or polysaccharide-based, and may or may not include perfume(s), odor-controlling substances and/or dust-controlling substances. The cartridge 16 can be designed and/or the litter can be formulated specifically for certain animals such as kittens, older cats, multiple cats, and so on. The type of litter material can be chosen and coordinated with the size of the cartridge chamber to provide a total weight below a certain desired threshold, to facilitate user handling and transport for example. In some scenarios, the litter and size of the cartridge chamber are provided so that the total weight of the litter is below 5 kg, below 3 kg, between 0.5 kg and 2.75 kg, between 0.75 kg and 2.5 kg, between 1.5 and 2.25 kg, or between 1.75 and 2 kg. In some cases, there could be more than 5 kg of litter material. In some scenarios, the litter material can be light weight animal litter material, such as an animal litter having a density between 20 and 50 lb/pi³. In some scenarios, the litter material can be fully disposable. It is understood that the litter material can be any type of absorbent material which is suitable for absorbing animal excretions.

### Odor-Control Substances Implementations

In some implementations, an odor-control substance can be integrated into the design. The odor-control substance can be added to the litter material and/or into one or more of the components of the litter box, cartridge, or garbage bag dispenser.

Various odor-control substances can be used. For example, an odor-neutralising substance (e.g., borax, carbon (e.g., activated), MgCl2) and/or an odor-retardant substance (e.g., N-(n-butyl) thiophosphoric triamide (nBTPT)) and/or bactericide like Bronopol can be used. In some scenarios, odor-control techniques or substances as described in patent application No. PCT/CA2011/000502, patent application No. PCT/CA2014/050844, and/or patent application No. PCT/CA2011/000502 can be employed.

### User Handling Implementations

The techniques described herein can enable improved handling and management of litter and waste materials. For example, various techniques enable the user to have little or no contact with the litter material and/or the waste material as part of the soiled litter. Reduced cleaning and maintenance are also facilitated. For instance, when the cartridge 16 and the garbage bag dispenser are used in tandem, the user can simply insert a new cartridge into the base, which pushes the soiled cartridge through the dispenser and into a tubular section of a garbage bag, which can then be tied off in order to dispose of the soiled cartridge. Thus, the user does not have to come into contact with the soiled cartridge. The garbage bag dispenser can include sufficient length of tubing, for example to form from three to twelve tied off bags, and the garbage bag dispenser can be replaced once the bags have been used up. The user is thus protected from contact with litter dust, soiled litter, and waste materials during litter handling and management.

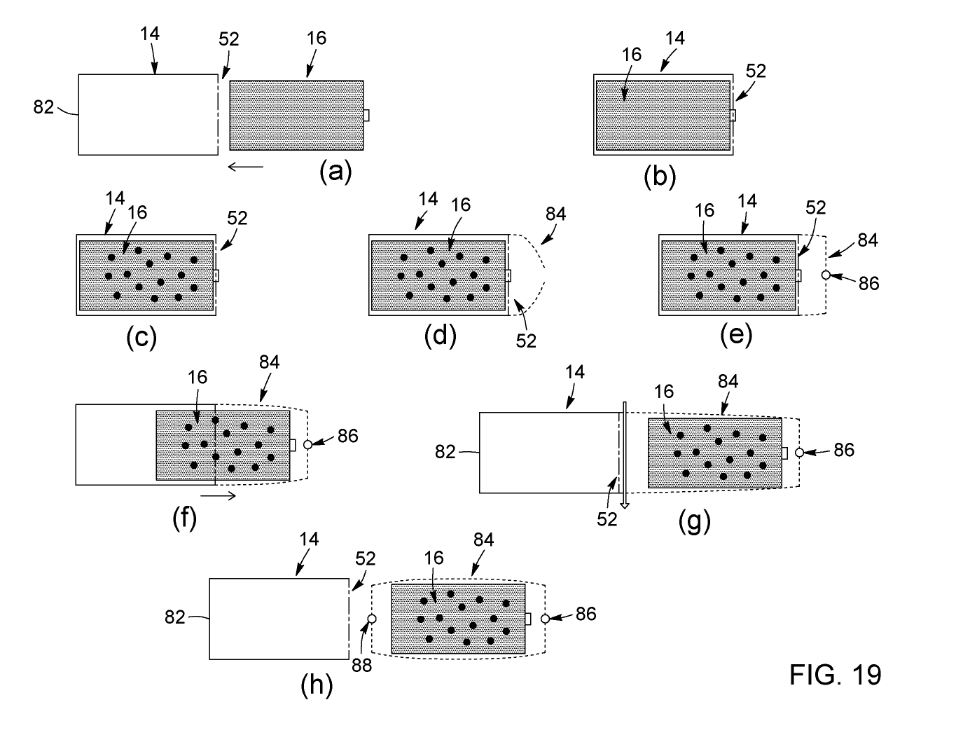

Now referring to FIG. 19, a base 14 is provided, and includes a back wall 82 and a garbage bag dispenser 52 mounted around an opening of the base component 14. A cartridge 16 is slidably inserted (A) into the base 14 through the opening. The cartridge 16 is positioned (B) into the base 14, and is ready to be used by an animal. When the cartridge 16 becomes soiled (C), the cartridge 16 needs to be removed. A tubular section 84 of a garbage bag can be pulled (D) from the garbage bag dispenser 52. The tubular section 84 of the garbage bag is then tied off (E) at a proximal end of the cartridge 16, for example to form a first knot 86. The cartridge 16 is pulled out (F) of the base 14 concurrently with the tubular section 84 of the garbage bag being pulled out of the garbage bag dispenser 52. When the cartridge is completely pulled out of the base 14, the tubular section 84 is cut (G) and tied off (H) at a distal end of the cartridge 16, for example to form a second knot 88. The soiled cartridge 16 which is thereby enclosed in a garbage bag, can be disposed of. It is understood that the tubular section 84 of the garbage bag can be tied off at either end using any suitable means, such as staples or the like. It is also understood that the garbage bag can be cut manually, or that cutting means can be provided directly on the garbage bag dispenser.

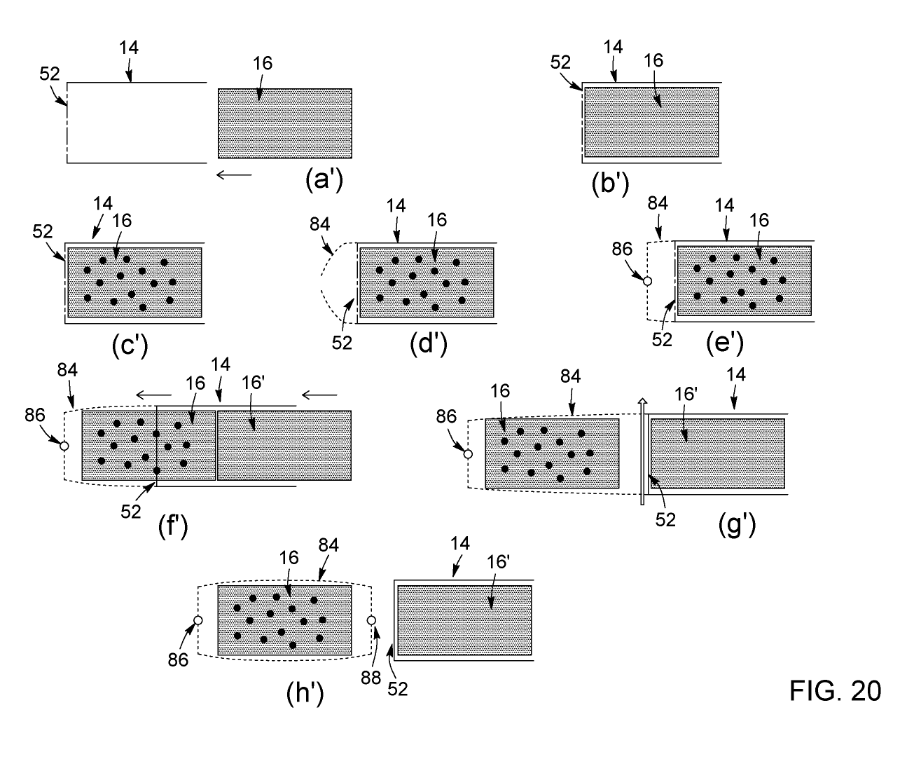

Now referring to FIG. 20, a base 14 is provided, and includes a back wall a garbage bag dispenser 52 mounted around a first opening located at a distal end of the base 14, and a second opening located at a proximal end of the base 14. A first cartridge 16 is slidably inserted (A′) into the base 14 through one of the openings. The first cartridge 16 is positioned (B′) into the base 14, and is ready to be used by an animal. When the first cartridge 16 becomes soiled (C′), the first cartridge 16 needs to be removed. A tubular section 84 of a garbage bag can be pulled (D′) from the garbage bag dispenser 52. The tubular section 84 of the garbage bag is then tied off (E′) at a distal end of the first cartridge 16, for example to form a first knot 86. A second cartridge 16′ is slidably inserted (F′) into the base 14 via the second opening, thereby slidably pushing the first cartridge 16 out of the base 14 via the second opening of the base 14 concurrently with the tubular section 84 of the garbage bag being pulled out of the garbage bag dispenser 52. When the first cartridge 16 is completely pulled out of the base 14, the tubular section 84 is cut (G′) and tied off (H′) at a proximal end of the first cartridge 16, for example to form a second knot 88. The first cartridge 16 which is thereby enclosed in a garbage bag, can be disposed of while the second cartridge 16′ is positioned in the base 14 and ready for use.

In some implementations, the litter material and cartridge 16 are sized and provided so that the cartridge 16 is ready to be changed after about seven or eight days of use by a single adult cat. This weekly changing of the cartridge 16 maintains the hygiene and cleanliness at an optimal level, although other frequencies are possible.

The techniques described herein can be used for various animals (e.g., cats) that have litter boxes or similar requirements. Some of the techniques described herein can also be adapted for other uses in the litter and/or waste management fields where waste materials (e.g., urine, excrement, bodily fluids, etc.) are produced.

1-47. (canceled)

48. A litter box, comprising:
a top cover;
a base mountable to the top cover to form a chamber for accommodating an animal, the base comprising:
a bottom section; and
side walls extending upward from the bottom section to define a base cavity, wherein at least one of the side walls comprises an opening sized and configured for removably receiving a litter-containing cartridge by translational displacement through the opening and into the base cavity; and
a connection mechanism provided proximate to an exit opening provided on one of the side walls of the base, the connection mechanism connecting a garbage bag dispenser to the corresponding side wall of the base.

49. The litter box of claim 48, wherein the connection mechanism is provided about the exit opening and is configured to connect an annular body of the garbage bag dispenser about the exit opening such that a central aperture defined by the annular body is aligned with the exit opening.

50. The litter box of claim 48, wherein the exit opening is the opening through which the cartridge is inserted.

51. The litter box of claim 48, wherein the exit opening is provided on an opposed side wall to the opening through which the cartridge is inserted.

52. The litter box of claim 48, wherein the base further comprises a guide system for guiding the translational displacement of the litter-containing cartridge into the base cavity.

53. The litter box of claim 52, wherein the guide system comprises a tongue-and-groove system.

54. The litter box of claim 53, wherein the tongue-and-groove system comprises a groove provided on at least one of the side walls of the base, the groove being co-operable with a corresponding tongue of the litter-containing cartridge.

55. The litter box of claim 53, wherein the tongue-and-groove system comprises a tongue provided on at least one of the side walls of the base, the tongue being co-operable with a corresponding groove of the litter-containing cartridge.

56. The litter box of claim 53, wherein the tongue-and-groove system comprises a groove on a first side wall of the base and a tongue on an opposed second side of the base, the groove and tongue of the base being co-operable with a corresponding groove and tongue of the litter-containing cartridge.

57. The litter box of claim 48, wherein the base further comprises a displacement-facilitating system for facilitating the translational displacement of the litter-containing cartridge into the base cavity.

58. The litter box of claim 57, wherein the displacement-facilitating system comprises a roller system.

59. The litter box of claim 58, wherein the roller system comprises a plurality of roller units mounted to the bottom section of the base.

60. The litter box of claim 59, wherein each roller unit comprises a wheel for contacting the litter-containing cartridge, an axel about which the wheel is mounted, and a frame having an upper portion to which the axel is mounted and a lower portion mounted to the bottom section of the base.

61. A litter box kit, comprising:
a top cover;
a base mountable to the top cover to form a chamber for accommodating an animal, the base comprising:
a bottom section; and
side walls extending upward from the bottom section to define a base cavity, wherein at least one of the side walls comprises an opening;
a cartridge sized and configured to be insertable through the opening and into the base cavity, the cartridge comprising:
a housing comprising a bottom part, side walls, and a removable top part defining a cartridge chamber; and
litter material provided within the cartridge chamber and being exposed below the chamber upon removal of the top part; and
a garbage bag dispenser comprising:
tubular plastic stock; and
an annular body comprising a compartment for housing the tubular plastic stock, the body being removably mountable to the base and sized and positioned about an exit opening provided in the base such that the cartridge is removable through the exit opening and into a portion of the tubular plastic stock for disposal.

62. A method for removing a litter-containing cartridge from a base of a litter box, the method comprising:
dispensing a portion of tubular plastic having a first end and a second end from a garbage bag dispenser mounted to the base of the litter box and positioned about an opening of the base;
sealing the portion of tubular plastic at the first end and keeping the second end connected to a tubular plastic stock housed in the garbage bag dispenser;
translationally displacing the litter-containing cartridge out of the base of the litter box, through the opening and into the sealed portion of tubular plastic;
severing the portion of tubular plastic from the tubular plastic stock at the second end; and
sealing the portion of tubular plastic at the second end and around the litter-containing cartridge.

63. The method of claim 62, wherein sealing the portion of tubular plastic at the first and second ends comprises tying off the portion of tubular plastic.

64. The method of claim 62, wherein translationally displacing the litter-containing cartridge comprises pulling the litter-containing cartridge out of the base of the litter box.

65. The method of claim 64, wherein pulling the litter-containing cartridge is performed by pulling on a handle provided on the litter-containing cartridge, through the sealed first end of the portion of tubular plastic.

66. The method of claim 62, wherein translationally displacing the litter-containing cartridge comprises pushing the litter-containing cartridge out of the base of the litter box by insertion of a second litter-containing cartridge into the base, via a second opening provided in the base.

67. The method of claim 66, wherein the litter box is a cat litter box.
